(19) United States
(12) Patent Application Publication
(10) Pub. No.: US 2013/0342436 A1
(43) Pub. Date: Dec. 26, 2013

(54) LAPTOP AND PROJECTOR DEVICE

(71) Applicant: Curtis Eaddy, Stratford, CT (US)

(72) Inventor: Curtis Eaddy, Stratford, CT (US)

(21) Appl. No.: 13/528,726

(22) Filed: Jun. 20, 2012

(51) Int. Cl. G06F 3/01

(52) U.S. Cl. 345/156

(57) ABSTRACT

The present invention is a laptop and projector device that includes a laptop computer, a projector incorporated into the laptop computer and a projector eye disposed in front of the projector. The laptop and projector device also includes a hand held remote control that controls the projector eye and the laptop computer and a projector eye cover plate with a pair of diagonal halves placed over the projector eye that open and close while placed over the projector eye. There is also a second embodiment of the laptop and projector device that removably attaches to a laptop computer or other suitable computer.

### TECHNICAL FIELD & BACKGROUND

Traditional methods of exhibiting images and text from a computer to a screen typically involve the use of an independent and bulky projector. This technique can be time consuming and complicated, requiring connective wires and plug-ins.

The present invention generally relates to a laptop device. More specifically, the invention is a laptop and projector device.

It is an object of the invention to provide a laptop and projector device that has a projector disposed on a back side of a laptop computer screen.

It is an object of the invention to provide a laptop and projector device that can be attached to a laptop computer top.

It is an object of the invention to provide a laptop and projector device that utilizes a panning and zooming projector eye that is controlled by a remote control device.

What is really needed is a laptop and projector device that has a projector disposed on a back side of a laptop computer screen that can be attached to a laptop computer top that utilizes a panning and zooming projector eye that is controlled by a remote control device.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a rear view of a laptop and projector device, according to an embodiment of the present invention.

FIG. 1B illustrates a front view of a projector eye of a laptop and projector device, according to an embodiment of the present invention.

FIG. 1C illustrates a front view of a remote control of a laptop and projector device, according to an embodiment of the present invention.

FIG. 1D illustrates a front view of a plurality of projector eye cover plates of a laptop and projector device, according to an embodiment of the present invention.

FIG. 2 illustrates a front view of a laptop and projector device, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

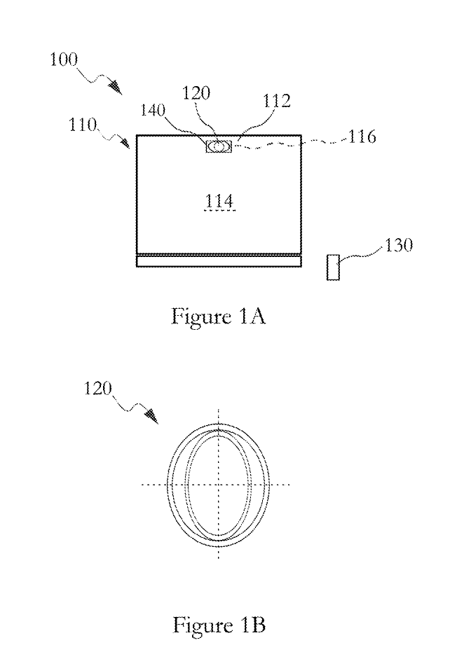

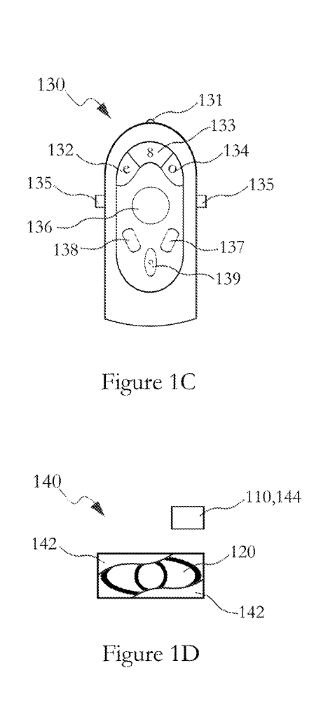

FIG. 1A illustrates a rear view of a laptop and projector device 100, according to an embodiment of the present invention.

The laptop and projector device 100 includes a laptop computer 110, a projector eye 120, a remote control 130 and a projector eye cover plate 140. The laptop computer 110 has a top backside 112 behind a computer screen 114 and also incorporates a projector 116 into the laptop computer 110. The laptop computer 110 can be any suitable laptop computer or desktop computer (not shown) that can accommodate all of the features of the laptop and projector device 100. The projector eye 120 is disposed on the top backside 112 of the laptop computer screen 114. Additional details regarding the projector eye 120 are provided in subsequent FIG. 1B. The remote control 130 is hand-held and controls the operations of the projector eye 120 and the laptop computer 110. Additional details regarding the remote control 130 are provided in subsequent FIG. 1C. The projector eye cover plate 140 is placed over the projector eye 120 and can be opened and closed while placed over the projector eye 120. Additional details regarding the projector eye cover plate 140 are provided in subsequent FIG. 1D.

FIG. 1B illustrates a front view of a projector eye 120 of a laptop and projector device 100, according to an embodiment of the present invention.

The projector eye 120 illustrated and described in FIG. 1B is similar to the projector eye 120 illustrated and described in FIG. 1A and its description. As previously described in FIG. 1A, the projector eye 120 is disposed on the top backside 112 of the laptop computer screen 114. As previously described in FIG. 1A the remote control 130 controls the projector eye 120 and the laptop computer 110. The projector eye 120 can tilt in a plurality of vertical directions and a plurality of horizontal directions (i.e., can tilt-up or down or move left or right in any direction.). The projector eye 120 can also zoom in 100% to focus on an object.

FIG. 1C illustrates a front view of a remote control 130 of a laptop and projector device 100, according to an embodiment of the present invention.

The remote control 130 illustrated and described in FIG. 1C is similar to the remote control 130 illustrated and described in FIG. 1A and its description. The remote control 130 includes a laser pointer 131, a web browser control button 132, a laptop control button 133, a laser pointer activation button 134, a pair of slide tabs 135, a scroll and zoom button 136, a right click mouse button 137, a return button 138 and a projector activation button 139.

The laser pointer 131 is disposed on the tip of the remote control 130 to communicate with the laptop computer 110. The web browser control button 132 controls one or more web browsing activities of the laptop computer 110 programmed by the remote control 130. The laptop control button 133 controls one or more laptop computer functions programmed by the remote control 130. The laser pointer activation button 134 activates and shuts-off the laser pointer 131. The slide tab 135 allows a user to slide a plurality of frames forward and backward during a presentation. The scroll and zoom button 136 controls the tilting and zooming movements of the projector eye 120 previously described in FIG. 1B. The right click mouse button 137 controls the right click mouse 111 of the laptop computer 110. The return button 138 returns a user to a previous setting on the laptop computer 110. The projector activation button 139 activates and shuts-off the projector eye 120.

FIG. 1D illustrates a front view of a plurality of projector eye cover plate 140 of a laptop and projector device 100, according to an embodiment of the present invention.

The projector eye cover plate 140 is placed over the projector eye 120 and can be opened and closed while placed over the projector eye 120 as previously described in FIG. 1A. The projector eye cover plate 140 illustrated in FIG. 1D is in a partially closed position.

The projector eye cover plate 140 includes a pair of diagonal halves 142. The pair of diagonal halves 142 can be diagonally moved and separated and is typically activated by clicking a desktop icon 144, exposing the projector eye 120 underneath the pair of diagonal halves 142. The pair of diagonal halves 142 can be diagonally moved back by again clicking a desktop icon 144 from the laptop computer 110 closing the projector eye 120 underneath the pair of diagonal halves 142.

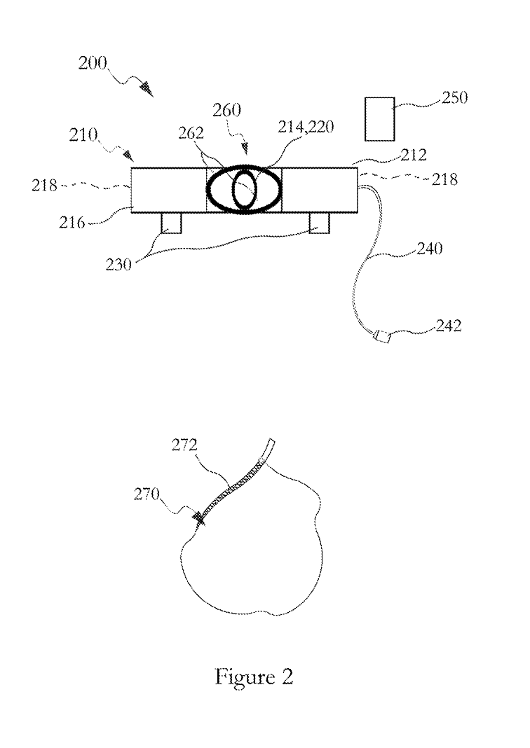

FIG. 2 illustrates a front view of a laptop and projector device 200, according to an embodiment of the present invention. The laptop and projector device 200 illustrated in FIG. 2 is removably attached to a top portion 202 of an existing laptop computer 204 or desktop computer (not shown).

The laptop and projector device 200 includes a base casing 210, a projector eye 220, a pair of clamps 230, a USB cable 240, a remote control 250, a projector eye cover plate 260 and a carrying case 270.

The base casing 210 has a front facing 212 with a middle portion 214, a bottom 216 and a plurality of vents 218. The projector eye 220 is disposed on the middle portion 214 of the front facing 212 of the base casing 210. The projector eye 220 is a similar projector eye 120 described and illustrated in FIG. 1A and its description. The pair of clamps 230 is disposed on the bottom 216 of the base casing 210 and removably attaches to the top portion 202 of an existing laptop computer 204. The pair of clamps 230 can swing outward from a tucked position to extend and attach the base casing 210 to the top portion 202 of an existing laptop computer 204. The USB cable 240 includes a USB plug 242 and extends from the base casing 210 to be inserted into a USB port (not shown). The remote control 250 is similar to the remote control 130 illustrated and described in FIG. 1C and its description and has similar features that includes a laser pointer 131, a web browser control button 132, a laptop control button 133, a laser pointer activation button 134, a pair of slide tabs 135, a scroll and zoom button 136, a right click mouse button 137, a return button 138 and a projector activation button 139. The projector eye cover plate 260 is similar to the projector eye cover plate 140 illustrated and described in FIG. 1D and its description and includes a similar pair of diagonal halves 262. The pair of diagonal halves 262 can be diagonally moved and separated exposing the projector eye 120 underneath the pair of diagonal halves 262. The pair of diagonal halves 262 is typically activated by clicking a desktop icon 264 and selecting yes, exposing the projector eye 120 underneath the pair of diagonal halves 262. The pair of diagonal halves 262 can be diagonally moved and separated back closing the projector eye 120 underneath the pair of diagonal halves 262. The carrying case 270 can conveniently contain and transport the laptop and projector device 200. The carrying case 270 includes a zipper 272 and is made of soft material such as leather or other suitable material.

The battery operated laptop and projector device provides users with a projector in a laptop computer or other hand held devices including MP3 players and desktop computers and displays high definition images. Activated by clicking a desktop icon, the eye cover plate at the back of the laptop screen slides open to reveal the projector eye and light, causing the images on the computer to appear on the adjacent screen or wall. The laptop and projector device is equipped with a remote control that an individual may use to manipulate the visual images from a distance using a laser pointer, toggle, on/off, back, forward, left right click, desktop and web browser buttons, allowing presenters to smoothly interact with their audience. Zoom, focus, size adjust and tilt options may be used to accommodate viewers with impaired vision. The laptop and projector device can be used in suitable laptops. The laptop and projector device is additionally offered as a separate portable device that may be affixed with clamps to the top of an existing laptop screen and connected through a universal serial bus (USB) cable. The laptop and projector device also features an optional three dimensional function, facilitating enhanced movie viewing.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A laptop and projector device, comprises:
a laptop computer with a top backside, said top backside is behind a computer screen;
a projector incorporated into said laptop computer;
a projector eye disposed on said top backside of said laptop computer screen, said projector eye disposed in front of said projector;
a hand held remote control that controls said projector eye and said laptop computer, said hand held remote control includes a laser pointer, a web browser control button, a laptop control button, a laser pointer activation button, a pair of slide tabs, a scroll and zoom button, a right click mouse button, a return button and a projector activation button; and
a projector eye cover plate with a pair of diagonal halves, said projector eye cover plate placed over said projector eye, said pair of diagonal halves is opened and closed while placed over said projector eye.

2. The laptop and projector device according to claim 1, wherein said projector eye tilts in a plurality of vertical directions and a plurality of horizontal directions.

3. The laptop and projector device according to claim 1, wherein said projector eye zooms in 100% to focus on an object.

4. The laptop and projector device according to claim 1, wherein said web browser control button controls one or more web browsing activities of said laptop computer.

5. The laptop and projector device according to claim 1, wherein said slide tab allows a user to slide a plurality of frames forward and backward during a presentation.

6. The laptop and projector device according to claim 1, wherein said scroll and zoom button controls said tilting and zooming movements of said projector eye.

7. The laptop and projector device according to claim 1, wherein said right click mouse button controls said right click mouse of said laptop computer.

8. The laptop and projector device according to claim 1, wherein said return button returns a user to a previous setting on said laptop computer.

9. The laptop and projector device according to claim 1, wherein said pair of diagonal halves are opened by clicking a desktop icon.

10. The laptop and projector device according to claim 9, wherein said pair of diagonal halves is closed by clicking said desktop icon.

11. A laptop and projector device, comprising:
a base casing with a front facing with a middle portion, a bottom and a plurality of vents;
a projector eye disposed on said middle portion of said front facing of said base casing, said projector eye tilts in a plurality of vertical directions and a plurality of horizontal directions and said projector eye zooms in 100% to focus on an object;
a pair of clamps disposed on said bottom of said base casing, said pair of clamps removably attach to said top portion of a laptop computer;
a USB cable with a UBS plug, said USB cable extends from said base casing and said UBS plug is inserted into a USB port;
a remote control that includes a laser pointer, a web browser control button, a laptop control button, a laser pointer activation button, a pair of slide tabs, a scroll and zoom button, a right click mouse button, a return button and a projector activation button;
a projector eye cover plate with a pair of diagonal halves, said projector eye cover plate is placed over said projector eye, said pair of diagonal halves is opened and closed while placed over said projector eye; and
a carrying case that includes a zipper, said carrying case contains and transports said laptop and projector device.

12. The laptop and projector device according to claim 11, wherein said pair of clamps swing outward from a tucked position to extend and attach said base casing to said top portion of said laptop computer.

13. The laptop and projector device according to claim 11, wherein said slide tab allows a user to slide a plurality of frames forward and backward during a presentation.

14. The laptop and projector device according to claim 11, wherein said scroll and zoom button controls said tilt and said zoom of said projector eye.

15. The laptop and projector device according to claim 11, wherein said right click mouse button controls said right click mouse of said laptop computer.

16. The laptop and projector device according to claim 11, wherein said return button returns a user to a previous setting on said laptop computer.

17. The laptop and projector device according to claim 11, wherein said pair of diagonal halves are opened by clicking a desktop icon.

18. The laptop and projector device according to claim 11, wherein said pair of diagonal halves is closed by clicking said desktop icon.

19. The laptop and projector device according to claim 11, wherein said carrying case is made of soft material.

20. The laptop and projector device according to claim 19, wherein said soft material is leather.
